(19) United States
(12) Patent Application Publication
(10) Pub. No.: US 2024/0172060 A1
(43) Pub. Date: May 23, 2024

(54) C-RNTI PROVISIONING FOR L1/L2 CENTRIC INTER-CELL MOBILITY

(71) Applicant: Telefonaktiebolaget LM Ericsson (PUBL), Stockholm (SE)

(72) Inventors: Pradeepa Ramachandra, LINKÖPING (SE); Icaro Leonardo Da Silva, SOLNA (SE); Helka-Liina Määttänen, ESPOO (FI)

(21) Appl. No.: 18/552,576

(22) PCT Filed: Apr. 1, 2022
(86) PCT No.: PCT/IB2022/053080

§ 371 Date: Sep. 26, 2023

Related U.S. Application Data
(60) Provisional application No. 63/169,822, filed on Apr. 1, 2021.

(51) Int. Cl. H04W 36/00

(52) U.S. Cl. CPC H04W 36/0077

(57) ABSTRACT

A method (1400) by a user equipment (UE) (510) includes receiving, from a network node (560), an indication of a list of UE identifiers for the UE to use in a target candidate cell after a Layer 1 or Layer 2 mobility procedure. The UE receives, from the network node via Layer 1 or Layer 2 signaling, an indication. Based on the indication, the UE determines a UE identifier among the list of UE identifiers to use at the target candidate cell after the Layer 1 or Layer 2 mobility procedure.

### PRIORITY

This application claims priority to U.S. Patent Provisional Application No. 63/169,822 filed on Apr. 1, 2021, entitled “On C-RNTI Provisioning for L1/L2 Centric Inter-cell Mobility,” the disclosure of which is hereby incorporated by reference.

### TECHNICAL FIELD

The present disclosure relates, in general, to wireless communications and, more particularly, systems and methods for Cell-Radio Network Temporary Identifier (C-RNTI) Provisioning for Layer 1 (L1)/Layer 2 (L2) centric inter-cell mobility.

### BACKGROUND

In Release 17 (Rel-17), Third Generation Partnership Project (3GPP) will standardize what has been called Layer 1 (L1)/Layer 2 (L2) centric inter-cell mobility (or L1-mobility, inter-Physical Cell Identifier (inter-PCI) Transmission Configuration Identifier (TCI) state change/update/modification, etc.). This is justified in the Work Item Description (WID) RP-193133 by the fact that, while Release 16 (Rel-16) manages to offer some reduction in overhead and/or latency, high-speed vehicular scenarios (e.g. a user equipment (UE) traveling at high speed on highways) at Frequency Range 2 (FR2) require more aggressive reduction in latency and overhead. This is true not only for intra-cell but also for L1/L2 centric inter-cell mobility.

L1/L2 inter-cell centric mobility allows a UE to receive a Layer 1 (L1) or Layer 2 (L2) signaling (instead of RRC signaling) indicating a Transmission Configuration Indicator (TCI) state (e.g. for Physical Downlink Control Channel (PDCCH)) possibly associated to an Synchronization Signal Block (SSB) whose PCI is not necessarily the same as the PCI of the cell the UE has connected to e.g. via connection resume or connection establishment. Moreover, it may be the case that the frequency band and/or SSB Absolute Radio Frequency Channel Number (ARFCN) of the current serving cell is also changed during the L1/L2 procedure.

FIG. 1 illustrates the path of a UE at different moments in time (i.e., T1, T2, T3, T4, and T5, as it passes through different coverage areas of different SSBs associated to different PCIs. The PCIs may be associated to the same cell or different cells. According to certain embodiments, that L1/L2-centric inter-cell mobility procedure can be interpreted as a beam management operation expanding the coverage of multiple SSBs associated to multiple PCIs (e.g. possibly associated to the same cell or different cells), possibly being an inter-frequency beam management. Current agreements that have been made concerning this feature may be found in RAN1 #102e and RAN1 #103c.

The Cell-Radio Network Temporary Identifier (C-RNTI) is a UE identity used for scheduling at cell level, is unique and used as an identifier of the RRC Connection.

In the DL, the gNodeB (gNB) can dynamically allocate resources to UEs via the C-RNTI on PDCCH(s). A UE always monitors the PDCCH(s) in order to find possible assignments when its DL reception is enabled (activity governed by Discontinuous Reception (DRX) when configured). When Carrier Aggregation (CA) is configured, the same C-RNTI applies to all serving cells (i.e., the SpCell and the Secondary Cells (SCell(s))) for a configured cell group, which may include, for example, a Master Cell Group (MCG) and/or a Secondary Cell Group (SCG).

In the UL, the gNB can dynamically allocate resources to UEs via the C-RNTI on PDCCH(s). A UE always monitors the PDCCH(s) in order to find possible grants for UL transmission when its DL reception is enabled (activity governed by DRX when configured). When CA is configured, the same C-RNTI applies to all serving cells (i.e., the SpCell and the SCell(s)) for a configured cell group, which may include, for example, a MCG and/or a SCG.

Section 4.2.2 of 3GPP TS 38.321 v. 15.3.0 discusses Medium Access Control (MAC) entities for MCG and SCG. Sections 5.3 and 5.4 of 4.2.2 of 3GPP TS 38.321 v. 15.3.0 discuss DL and UL shared channel data transfer, respectively.

A C-RNTI needs to be assigned by the network to the UE when the UE enters RRC_CONNECTED. Hence, the UE needs to obtain a C-RNTI for the MAC entity associated with the MCG during the transition from RRC_IDLE (or RRC_INACTIVE) to RRC_CONNECTED. That happens as part of the random access (RA) procedure. Specifically, the UE sends a preamble and receives Temporary C-RNTI (TC-RNTI) in a Random Access Response (RAR), together with an UL grant for a message 3 (MSG.3) transmission. Then, the UE transmits MSG.3 using the TC-RNTI and waits for a message 4 (MSG.4) from the network (contention resolution MAC Control Element (MAC CE) with a version of Common Control Channel (CCCH) Service Data Unit (SDU) from MSG.3.). Upon reception of MSG.4 including an identifier (contention resolution ID) the UE compares the received contention resolution ID with its TC-RNTI and their matching is an indication that contention was resolved and the UE sets the C-RNTI to the value of its TC-RNTI. This is discussed in more detail in Sections 5.1.4, 6.1.5, 6.2.2, 6.2.3 of 3GPP TS 38.321.

Certain problems exist, however. For example, R1-2102248 may stir questions related to the need for updating the C-RNTI to be used in the area where the L1-L2 mobility can be enabled as follows:
1. Is there a need to assign to a UE a separate C-RNTI for DL reception from and UL transmission to a non-serving cell, or can the same C-RNTI from the serving cell be reused, at least for transmission and reception on UE-dedicated Physical Downlink Shared Channel (PDSCH), PDCCH, Physical Uplink Shared Channel (PUSCH), and Physical Uplink Control Channel (PUCCH)?
2. In restricting the use of the same C-RNTI for serving and non-serving cells, what would be the impact in applicable use cases and/or required specification support, if any?
3. If separate C-RNTIs are considered necessary in some cases, for serving and non-serving cells, how would this be configured for UE, i.e. is RRC reconfiguration signaling or some other (dynamic) signaling needed for configuring the separate C-RNTI(s)?

As explained above, the C-RNTI is a unique UE identifier associated to a MAC entity, i.e. associated to the secondary group primary cell (SpCell) (e.g., PCell the UE was handed over or the PCell the UE transitions to RRC_CONNECTED) and the configured SCell(s) e.g. for the MCG and/or the SCG. The existing solutions to update and/or assign the C-RNTI are the following:
According to a first existing solution, in the RRC Reconfiguration procedure (RRCReconfiguration message), the assigned C-RNTI for the target cell is included in the IE Reconfiguration WithSync (L3 handover, SCG addition, PSCell change). In other words, this requires an RRC message and a reconfiguration with sync with target cell/target PCI.
According to a second existing solution, in the RA procedure, the assigned C-RNTI is included in the RAR (initially as a Temporary C-RNTI), and later provided in the MAC CE for contention resolution to indicate that the C-RNTI shall be considered as the Temporary C-RNTI.
   In the context of L1/L2 centric mobility, a problem with the existing solutions may include that the UE should be able to change its serving cell (SpCell, PCell, SPcell) without the need of RRC signaling (and/or reconfiguration with sync). As a result, the first existing solution is not desirable. Another problem with the existing solutions may be that, in L1/L2 centric mobility, the UE should be able to change its serving cell (i.e., SpCell, PCell, SPcell) without the need to perform random access. For example, the UE should be able to receive the MAC CE for changing cell and start monitoring PDCCH in that target cell such as, for example, if one assumes that source and target cells for L1 mobility are time aligned.

### SUMMARY

Certain aspects of the present disclosure and their embodiments may provide solutions to these or other challenges. For example, according to certain embodiments, methods and systems are provided to enable dynamic changes in the C-RNTI assigned to the UE via non-RRC signaling.

According to certain embodiments, a method by a UE includes receiving, from a network node, an indication of a list of UE identifiers for the UE to use in a target candidate cell after a L1 or L2 mobility procedure. The UE receives, from the network node via L1 or L2 signaling, an indication. Based on the indication, the UE determines a UE identifier among the list of UE identifiers to use at the target candidate cell after the L1 or L2 mobility procedure.

According to certain embodiments, a UE is adapted to receive, from a network node, an indication of a list of UE identifiers for the UE to use in a target candidate cell after a L1 or L2 mobility procedure. The UE is adapted to receive, from the network node via L1 or L2 signaling, an indication. Based on the indication, the UE is adapted to determine a UE identifier among the list of UE identifiers to use at the target candidate cell after the L1 or L2 mobility procedure.

According to certain embodiments, a method by a network node includes transmitting, to a UE, an indication of a list of UE identifiers for the UE to use in a target candidate cell after a L1 or L2 mobility procedure. The network node transmits, to the UE via L1 or L2 signaling, an indication of a change from a source cell to a target cell, and the indication enables the UE to determine, among the list of UE identifiers, a UE identifier to use at the target candidate cell after the L1 or L2 procedure.

According to certain embodiments, a network node is adapted to transmit, to a UE, an indication of a list of UE identifiers for the UE to use in a target candidate cell after a L1 or L2 mobility procedure. The network node is adapted to transmit, to the UE via L1 or L2 signaling, an indication of a change from a source cell to a target cell, and the indication enables the UE to determine, among the list of UE identifiers, a UE identifier to use at the target candidate cell after the L1 or L2 procedure.

Certain embodiments may provide one or more of the following technical advantages. For example, one technical advantage may be that certain embodiments allow a network to re-use a C-RNTI within a total area where the L1-L2 mobility is enabled.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the path of a UE at different moments in time as it passes through different cells associated with different PCIs;

FIG. 2 illustrates an example SSB, according to certain embodiments;

FIG. 3 illustrates an example of a MAC, according to certain embodiments;

FIG. 4 illustrates an example structure of the MAC CE that can be used to update the C-RNTI associated to a UE, according to a particular embodiment;

FIG. 5 illustrates an example wireless network, according to certain embodiments;

FIG. 6 illustrates an example network node, according to certain embodiments;

FIG. 7 illustrates an example UE, according to certain embodiments;

FIG. 8 illustrates a virtualization environment in which functions implemented by some embodiments may be virtualized, according to certain embodiments;

FIG. 9 illustrates a telecommunication network connected via an intermediate network to a host computer, according to certain embodiments;

FIG. 10 illustrates a generalized block diagram of a host computer communicating via a base station with a user equipment over a partially wireless connection, according to certain embodiments;

FIG. 11 illustrates a method implemented in a communication system, according to one embodiment;

FIG. 12 illustrates another method implemented in a communication system, according to one embodiment;

FIG. 13 illustrates another method implemented in a communication system, according to one embodiment;

FIG. 14 illustrates another method implemented in a communication system, according to one embodiment;

FIG. 15 illustrates an example method by a UE, according to certain embodiments; and

FIG. 16 illustrates an example method by a network node, according to certain embodiments.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

Additionally, terminologies such as base station/gNB and UE should be considered non-limiting and do in particular not imply a certain hierarchical relation between the two; in general, “gNB” could be considered as device 1 and “UE” could be considered as device 2 and these two devices communicate with each other over some radio channel. And in the following the transmitter or receiver could be either gNB, or UE.

The term “beam” used in the text can correspond to a reference signal that is transmitted in a given direction. For example, if may refer to an SS/PBCH Block (SSB) or layer 3 configured CSI-RS. During a half-frame, different SSBs may be transmitted in different spatial directions (i.e. using different beams, spanning the coverage area of a cell).

The term PCI and/or PCI of an SSB is used and may correspond to the physical cell identity encoded by a Primary Synchronization Sequence (PSS) and an a Secondary Synchronization Sequence (SSS) that are comprised in an SSB. FIG. 2 illustrates an example SSB 200, as defined in 3GPP TS 38.211, in which the PSS and SSS encode a PCI.

Certain embodiments relate to “cells” or a “set of cells” for which the UE can be configured with to perform L1/L2 centric mobility. This set of cells may be called a set of intra-frequency neighbour cells and are cells on which the UE performs measurements and to which the UE can perform a handover/reconfiguration with sync. Alternatively, this set of cells may be a set of intra-frequency non-serving cells or simply a set of non-serving cells (in addition to the serving cell). As another alternative, this set of cells may be the cells that the UE can use to perform L1 based mobility and can be called candidate SpCells, additional SpCells, the SpCell and non-serving cells (configured candidates for L1 based mobility), etc.

Any ASNI encoding presented herein is a modification of and/or builds upon 3GPP TS 38.331, which relates to the Rel-16 specifications for RRC. 3GPP TS 38.311 provides a reference for Information Elements (IEs) and fields in the messages and/or IEs herein and any proposed modifications thereto are intended to implement the methods and techniques described herein. However, it is recognized that these are merely provided as examples and the actual implementation of such signaling in the specification may differ.

The element “Secondary Cell” refers to a cell configured at the UE for CA, i.e. to be used as a component carrier. That same term is used for NR such as, for example, in 3GPP TS 38.331, and in EUTRA such as, for example, in 3GPP TS 36.331. However, the term is applicable to any type of cells with a different terminology that may be configured at the UE for CA, or, for a UE configured with CA, a cell providing additional radio resources on top of Special Cell/PCell, PSCell, or any sort of cell considered as a main cell or a higher hierarchy cell.

The term CORESET refers to a Control Resource Set, as defined in 3GPP TS 38.300. A UE monitors a set of PDCCH candidates in the configured monitoring occasions in one or more configured COntrol REsource SETs (CORESETs) according to the corresponding search space configurations. A CORESET consists of a set of Physical Resource Blocks (PRBs) with a time duration of 1 to 3 Orthogonal Frequency Division Multiplexing (OFDM) symbols. The resource units Resource Element Groups (REGs) and Control Channel Elements (CCEs) are defined within a CORESET with each CCE consisting a set of REGs. Control channels are formed by aggregation of CCE. Different code rates for the control channels are realized by aggregating different number of CCE. Interleaved and non-interleaved CCE-to-REG mapping are supported in a CORESET.

Certain embodiments may be described as including that the “UE receives” a message such as, for example, a MAC CE. This may correspond to the UE receiving a network function from a network node, such as a Distributed Unit (DU) of a gNodeB in a Next Generation Radio Access Network (NG-RAN), or a Centralized Unit (CU), or a node performing a Baseband functionality.

Though certain embodiments are described herein as being applicable to C-RNTI, the methods and techniques described herein are not be limited to that. It is recognized that the methods and techniques are about and applicable to any UE identifiers, such as the C-RNTI, that are associated to at least one of the following: i) the serving cell the UE is connected to, the SpCell the UE is connected to (e.g. PCell or PSCell), ii) the MAC entity the UE is configured with, iii) the cell group the UE is configured with e.g. MCG, SCG. Another example of an UE identifier could be the Inactive-RNTI (I-RNTI).

Certain embodiments refer to the term “L1/L2 inter-cell centric mobility” as used in the Work Item Description in 3GPP. However, it is recognized that the terms L1/L2 mobility, L1-mobility, L1 based mobility, L1/L2-centric inter-cell mobility or L1/L2 inter-cell mobility, L1-L2 mobility, L1-L2 centric inter-cell mobility, and L1-L2 inter-cell mobility may also be interchangeably used. Even though 3GPP has not decided how a L1/L2 inter-cell centric mobility should be standardized, the understanding for the purpose of embodiments described herein (i.e., the derivation of cell quality such as, for example, a computation of the Reference Signal Received Power (RSRP) of a serving cell) is that the UE in RRC_CONNECTED is connected (i.e. being served by) to a serving cell (SpCell), considered to be the PCell such as, for example, after the UE performs connection setup, if transitioning from RRC_IDLE to RRC_CONNECTED, or connection resume, transitioning from RRC_INACTIVE to RRC_CONNECTED, wherein the UE has a first PCI associated to that PCell i.e. the PCI in ServingCellConfigCommon/SIB1 for the cell the UE was camping on when it performed the random access for the transition to RRC_CONNECTED (e.g. denoted PCI-1). In the multi-beam scenario, a cell can be associated to multiple SSBs, and during a half-frame, different SSBs may be transmitted in different spatial directions (i.e. using different beams, spanning the coverage area of a cell).

Even though the term “L1/L2 inter-cell centric mobility” has the term “inter-cell”, a serving cell configuration may have more than one PCI associated to it. For that, there are at least two approaches that may be used to create that association:
Intra-cell multi-PCI L1/L2 centric mobility, where the same serving cell configuration is associated to more than one PCI (e.g. a TCI state configuration within ServingCellConfig can be associated to a PCI, which can be different from the PCI in ServingCellConfigCommon). For example, that means that the UE has an SpCell (serving cell) associated to one or multiple PCIs, and, the UE can receive a Layer 1 or Layer 2 signaling (e.g. a MAC CE, as defined in 3GPP TS 38.321) that indicates to the UE that the PCI of the SpCell needs to be changed such as, for example, from PCI-1 to PCI-2. That can be done by associating, in RRC signaling, the SSB of PCI-2, configured as Quasi-Co-Location (QCL) source of a TCI state (indicated by TCI state Id-X) that is indicated in the MAC CE. Then, upon receiving that MAC CE with TCI State Id-X, the UE knows it needs to change to PCI-2 and possibly consider actions related to UE identifiers, such as C-RNTI(s), as described in certain embodiments.
Inter-cell multi-PCI L1/L2 centric mobility, where the UE has several serving cell configurations with respective PCIs associated but a TCI state may refer to other cell PCIs (e.g. other serving cell or, even a non-serving cell the UE can move to with L1/L2 centric mobility). For example, that means that the UE is configured with multiple SpCell(s) (serving cells), each having their own PCI; and, the UE can receive a Layer 1 or Layer 2 signaling (e.g. a MAC CE) that indicates to the UE that the serving cell (e.g. SpCell) needs to be changed such as, for example, from cell associated to PCI-1 to cell associated to PCI-2. That can be done by associating, in RRC signaling, the SSB of cell associated to PCI-2, configured as QCL source of a TCI state (indicated by TCI state Id-X) that is indicated in the MAC CE. Then, upon receiving that MAC CE with TCI State Id-X, the UE knows it needs to change to PCI-2 and possibly consider actions related to UE identifiers, such as C-RNTI(s), as described in some embodiments.

The feature for L1/L2 mobility, as considered herein, considers both a handover case (PCell mobility) or PSCell change.

For example, according to certain embodiments, a method by a network node such as, for example, a gNB, includes transmitting, to a UE, at least one UE identifier (such as the C-RNTI or another identifier) via a RRC configuration. Only one of the UE identifier is used at any given point in time. The method further includes ways of signaling a change (update, assignment) of the C-RNTI or other identifiers to be used by the UE via non-RRC signaling. Examples of such non-RRC signaling include MAC signaling such as for example by way of a MAC CE.

For example, according to certain embodiments, a method by a UE includes receiving, by the UE, at least one UE identifier (such as the C-RNTI or another identifier) via the RRC configuration. In an embodiment, the UE identifier may be received from a network node (e.g. gNB). Only one of the UE identifier is used at any given point in time. The UE may receive the identifier, via non-RRC signaling, such as MAC signaling, by way of a MAC CE, for example.

More specifically, a method by a UE includes one or more of the following steps:
1) The UE receives a list of C-RNTIs, as part of an RRC procedure and within one or multiple RRC message such as, for example, as part of the RRC Reconfiguration procedure, within an RRCReconfiguration message; or, as part of the RRC Resume procedure, within an RRCResume message;
   a. The network node such gNB, transmits to the UE a list of C-RNTIs, as part of an RRC procedure and within one or multiple RRC message such as, for example, as part of the RRC Reconfiguration procedure, within an RRCReconfiguration message; or, as part of the RRC Resume procedure, within an RRCResume message;
2) The UE receives an indication of a C-RNTI to be used by the UE via lower layer signaling (e.g., MAC CE). The “indication” step may correspond to the UE action of updating the used C-RNTI, assigning a new C-RNTI according to the indication, and/or changing to a new C-RNTI according to the indication.
   a. The network node transmits to the UE an indication of a C-RNTI to be used by the UE via lower layer signaling (e.g., MAC CE). The “indication” step may correspond to the UE an action of updating the used C-RNTI, assigning a new C-RNTI according to the indication, and/or changing to a new C-RNTI according to the indication.
   b. The method also includes the possibility of the indication being transmitted in a MAC CE including the UE identifier, such as the C-RNTI. In one option, that is a newly defined “(new) C-RNTI MAC CE” received in a DL Channel by the UE (e.g. DL Shared Channel—DL-SCH) and associated to a logical channel assigned for that purpose so that, upon reception, the UE is aware that this MAC CE is for indicating (assigning the C-RNTI e.g. in a L1 based mobility). In one option, the new MAC CE contains a field that contains the C-RNTI of the MAC entity to be used by the UE's MAC entity. In one option, the length of the field is 16 bits. In an embodiment, this new MAC CE is not the RAR, and the C-RNTI is not received by the UE as part of the RA procedure (and/or in response to a transmission, like the preamble transmission).
   c. The method optionally includes the possibility of steps 1 and 2 being combined so that the UE receives a list of C-RNTIs via RRC signaling and receives an indication via lower layer signaling of which of the configured C-RNTIs the UE shall use.

In step 1 described above, the UE can receive a list of UE identities/identifiers (such as C-RNTIs) that is common for all PCIs/cells that are candidates to be the target cell in L1-L2 inter-cell mobility. For example, the list can have one or more UE identifiers and the list may be common to all cells provided in a list of SpCell as part of the cell group configuration. In an embodiment, the UE receives this information outside the cell specific configurations and outside the cell group configuration. In a particular embodiment, the C-RNTI list may be provided in an RRC message such as, for example, a RRCReconfiguration message:

| RRCReconfiguration-IEs :: = | | SEQUENCE { |
|---|---|---|
| radioBearerConfig | RadioBearerConfig | OPTIONAL, -- |
| Need M | | |

| | |
|---|---|
| secondaryCellGroup | OCTET STRING (CONTAINING |

CellGroupConfig) OPTIONAL, -- Cond SCG

| measConfig | | MeasConfig |
|---|---|---|
| OPTIONAL, -- Need M | | |
| ..., | | |
| c-RNTIList-r17 | C-RNTIList-r17 | |
| OPTIONAL, -- Need M | | |
| nonCriticalExtension | | SEQUENCE { } |
| OPTIONAL | | |
| } | | |

| | |
|---|---|
| C-RNTIList-r17 ::= | SEQUENCE (SIZE (1..maxC-RNTI- |

r17)) OF RNTI-Value

This common list of UE identifiers, which is received outside the cell group configuration in step 1 above, contains C-RNTIs for MCG and/or SCG. The elements in the list (or any other data structure like a set or sequence) could be assigned to the MAC entity of the MCG and/or the SCG. The C-RNTI can be assigned by the UE receiving a MAC CE (or any other lower layer signaling) including an indication of the C-RNTI (e.g., pointer to one element in the list of C-RNTIs) and an indication of which cell group this corresponds to (e.g. cell group Identifier). The C-RNTI can be also assigned by the UE receiving a MAC CE or lower layer signaling including an indication of the C-RNTI and, if that MAC CE or lower layer signaling has been received via the MCG (e.g. via the PCell) that means the C-RNTI is assigned for the MCG; or if that MAC CE or lower layer signaling has been received via the SCG (e.g. via the PSCell) that means the C-RNTI is assigned for the SCG.

In another particular embodiment, the C-RNTI list received in step 1 may be provided in a cell group configuration message:

| | |
|---|---|
| CellGroupConfig ::= | SEQUENCE { |
| cellGroupId | CellGroupId, |
| ..., | |
| [[ | |
| c-RNTIList-r17 | C-RNTIList-r17 |
| OPTIONAL, -- Need M | |
| ]] | |
| } | |
| C-RNTIList-r17 ::= | SEQUENCE (SIZE (1 .. maxC-RNTI- |
| r17)) OF RNTI-Value | |

This common list of UE identifiers (e.g. within the cell group configuration as described above as step 1 contains C-RNTIs for each cell group, e.g. MCG and/or SCG. The elements in the list (or any other data structure like a set or sequence) could be assigned to the MAC entity of the MCG if configured in the MCG configuration, and/or the SCG if configured in the SCG configuration.

In an embodiment, the C-RNTI is assigned by the UE receiving a MAC CE or DCI (or any other lower layer signaling) including an indication of the C-RNTI (e.g. pointer to one element in the list of C-RNTIs) indicating which C-RNTI is to be assigned from the list of C-RNTI of a given cell group. For example, the C-RNTI is assigned by the UE receiving a MAC CE (or DCI) including an indication of the C-RNTI and, if that MAC CE has been received via the MCG (e.g. via the PCell) that means this is assigning the C-RNTI for the MCG and the indication indicates a C-RNTI in the list of C-RNTIs configured in the MCG configuration. For example, the C-RNTI is assigned by the UE receiving a MAC CE (or lower layer signaling) including an indication of the C-RNTI and, if that MAC CE has been received via the SCG (e.g. via the PSCell) that means this is assigning the C-RNTI for the SCG and the indication indicates a C-RNTI in the list of C-RNTIs configured in the SCG configuration.

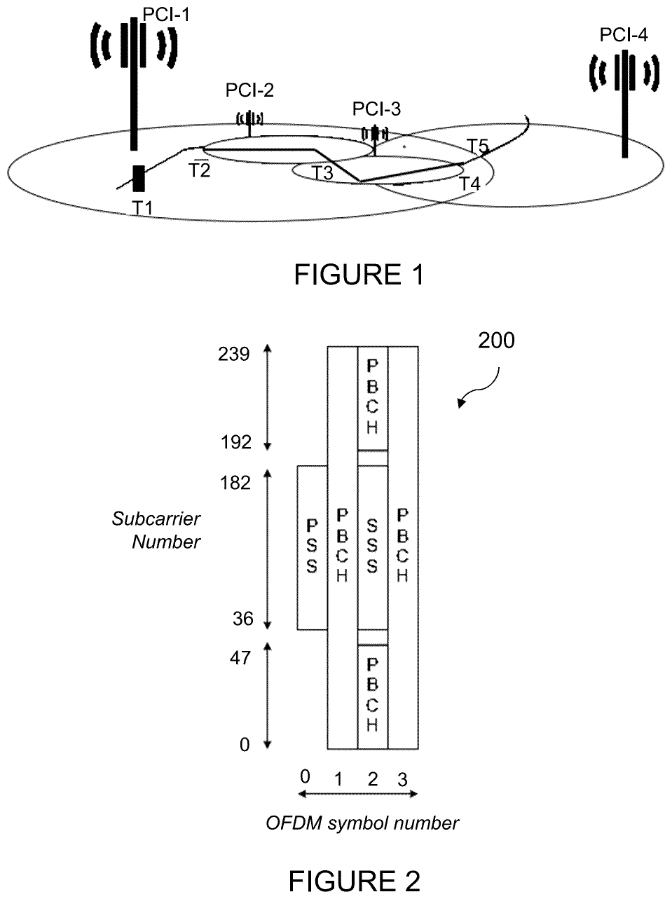

Returning to FIG. 1 as an example scenario, the UE may receive a single C-RNTI list (at step 1 described above) that is applicable for all four PCIs. The MAC CE based solutions discussed above can be used to select the active C-RNTI to be used by the UE from the list. The selection is independent of which amongst these four PCI is the current serving PCI for the UE.

In an embodiment, each configured C-RNTI in the common list is associated to an SpCell that is configured as a target candidate cell for L1 mobility (an SpCell, cell, PCI or non-serving cell that the UE can move to with a Layer 1 or Layer 2 signaling). In that case, upon receiving a command to change from one cell (e.g. cell-A) to another (cell-B), e.g. a MAC CE for L1 mobility, the UE changes its C-RNTI from the C-RNTI used in cell A to the C-RNTI configured for cell-B (as shown below):
L1 mobility MAC CE for target Cell-A→C-RNTI(1)
L1 mobility MAC CE for target Cell-B→C-RNTI(2)
L1 mobility MAC CE for target Cell-C→C-RNTI(3)
L1 mobility MAC CE for target Cell-D→C-RNTI(4)

According to certain other embodiments, at step 1, the UE may receive individual C-RNTI lists that are applicable to different PCIs/cells associated to L1/L2 inter cell mobility. More specifically, there can be multiple lists of C-RNTIs. At least one list is provided at step 1 for each of the cells that are considered as target candidate cells (i.e. that may be a target cell/PCI) in the L1-L2 mobility. In this case, the current list of C-RNTIs (amongst which the lower layer can select an individual value) is based on the current serving cell/PCI/SpCell of the UE. So, at the time of performing the L1-L2 inter-cell mobility (the serving PCI/cell/SpCell changes), for example, upon reception of a MAC CE for L1 mobility, the list of C-RNTIs that the UE considers for selecting the C-RNTI to be used in the target cell that is applicable changes implicitly, according to the target cell for L1 mobility. The advantages of this solution compared to a common list of C-RNTIs is that the already existing planning of PCI specific C-RNTI values can be reused to create a PCI specific possible C-RNTI list. This would also require less bits in the MAC CE for the purpose of selecting a specific C-RNTI as the number of C-RNTIs in a single PCI is expected to be smaller than the number of C-RNTIs amongst multiple PCIs.

As described above, at step 2, the UE receives, via lower layer signaling (i.e., Layer 1 or Layer 2 signaling), an indication of a C-RNTI to be used by the UE. In an embodiment, for example, the C-RNTI is assigned by the UE receiving a MAC CE (or any other lower layer signaling) including an indication of the C-RNTI (e.g. pointer to one element in the list of C-RNTIs). For example, as described above with regard to step 2a, a the C-RNTI is assigned by the UE receiving a first MAC CE or lower layer signaling including an indication of the C-RNTI (referred to as “C-RNTI MAC CE”) and, if that C-RNTI MAC CE or lower layer signaling has been received via the MCG (e.g. via the PCell) that means this is assigning the C-RNTI for the MCG; or if that MAC CE or lower layer signaling has been received via the SCG (e.g. via the PSCell) that means this is assigning the C-RNTI for the SCG. The UE can be aware of which list of MAC CEs to search the C-RNTI to be used based on the content of a second MAC CE received in the same MAC PDU, where the second MAC PDU can be a MAC CE for L1 based mobility (indicating implicitly or explicitly the PCI/cell that is the target). For example, the UE determines the list of C-RNTIs to consider by determining the target PCI/cell in the second MAC CE.

In another embodiment, and as described above with regard to step 2b, the C-RNTI is assigned by the UE receiving a MAC CE (or any other lower layer signaling) including an indication of the C-RNTI (e.g. pointer to one element in the list of C-RNTIs), in the same MAC CE used for L1 based mobility. When using the same MAC CE, preferably in one of the octets above the C-RNTI octet, a one bit field is provided that describes whether the C-RNTI field/octet is present in the MAC CE or not.

An example of such a configuration is given below where the spCellConfigList provides a list of PCIs on the current SpCell operating frequency. There will be a list of C-RNTI values for each of the SpCell configurations.

| | |
|---|---|
| CellGroupConfig ::= | SEQUENCE { |
| cellGroupId | CellGroupId, |
| ..., | |
| [[ | |
| spCellConfigList | |

SpCellConfigList OPTIONAL, -- Need M

| | |
|---|---|
| ]] | |
| } | |
| SpCellConfigList ::= | SEQUENCE (SIZE |

(1..maxSpCellperFreq)) OF SpCellConfig
-- Serving cell specific MAC and PHY parameters for a SpCell:

| | |
|---|---|
| SpCellConfig ::= | SEQUENCE { |

servCellIndex ServCellIndex

| | |
|---|---|
| OPTIONAL, -- Cond SCG | |
| reconfigurationWithSync | ReconfigurationWithSync |

OPTIONAL, -- Cond ReconfWithSync

| | |
|---|---|
| rlf-TimersAndConstants | SetupRelease { RLF- |
| TimersAndConstants } OPTIONAL, | -- Need M |
| rlmInSyncOutOfSyncThreshold | ENUMERATED {n1} |
| OPTIONAL, -- Need S | |
| spCellConfigDedicated | ServingCellConfig |
| OPTIONAL, -- Need M | |
| ..., | |
| [ [ | |
| c-RNTIList-r17 | C-RNTIList-r17 OPTIONAL, -- |
| Need M | |
| ] ] | |
| } | |
| C-RNTIList-r17 ::= | SEQUENCE (SIZE (1..maxC-RNTI- |
| r17)) OF C-RNTI-Value | |

Returning to the scenario depicted in FIG. 1, the UE may receive one C-RNTI list per PCI. In this case, the UE receives four C-RNTI lists (c-RNTIList1 in association with PCI1, c-RNTIList2 in association with PCI2, c-RNTIList3 in association with PCI3 and c-RNTIList4 in association with PCI4). For example, when the UE is being served by PCI-1, the MAC CE based solutions described above can be used to select the active C-RNTI to be used by the UE from the c-RNTIList1. Likewise, when the UE is being served by PCI-2, the MAC CE based solutions described above can be used to select the active C-RNTI to be used by the UE from the c-RNTIList2.

In yet another particular embodiment, the list of C-RNTI is common for a subset of PCIs involved in the L1-L2 mobility. Thus, more than one PCI will use the same list of C-RNTI. When the UE is being served by one of these PCIs, the lower layer signaling received in step 2 can be used to select a specific C-RNTI amongst the list of C-RNTI received in step 1.

Returning again to FIG. 1, the UE might receive one C-RNTI list associated to PCI-1 and PCI-2 and another C-RNTI list associated to PCI-3 and PCI-4. Thus, in all, the UE receives two C-RNTI lists (c-RNTIList1 in association with PCI1 and PCI2, c-RNTIList2 in association with PCI3 and PCI4). When the UE is being served by PCI-1 or PCI-2, the MAC CE based solutions described above can be used to select the active C-RNTI to be used by the UE from the c-RNTIList1. Likewise, when the UE is being served by PCI-3 or PCI-4, the MAC CE based solutions described above can be used to select the active C-RNTI to be used by the UE from the c-RNTIList2.

According to certain embodiments, in step 1, the RRC provides a list of C-RNTI lists without any association to the PCIs. The lower layer signaling is used to select both a specific list of C-RNTI lists and a specific C-RNTI in that C-RNTI list. This method completely removes the C-RNTI allocation dependencies with the PCI and this can also benefit from requiring less bits to change the C-RNTI at some inter-cell mobility depending on how the list of lists is structured (different lists can be of different sizes). An example is provided below:

| RRCReconfiguration-IEs ::= | | SEQUENCE { |
|---|---|---|
| radioBearerConfig | RadioBearerConfig | OPTIONAL, -- |

Need M

| | |
|---|---|
| secondaryCellGroup | OCTET STRING (CONTAINING |

| | |
|---|---|
| CellGroupConfig) OPTIONAL, -- Cond SCG | |
| measConfig | MeasConfig |
| OPTIONAL, -- Need M | |
| ..., | |
| c-RNTIListofList-r17 | C-RNTIListofList-r17 |
| OPTIONAL, -- Need M | |
| nonCriticalExtension | SEQUENCE { } |
| OPTIONAL | |
| } | |
| C-RNTIListofList-r17 ::= | SEQUENCE (SIZE (1..maxC- |
| RNTIList-r17)) OF C-RNTIList-r17 | |
| C-RNTIList-r17 ::= | SEQUENCE (SIZE (1..maxC-RNTI- |
| r17)) OF C-RNTI-Value | |

For example, the UE might receive two C-RNTI lists (c-RNTIList1 and c-RNTIList2). c-RNTIList1 might contain 64 different C-RNTI values whereas c-RNTIList2 might contain 8 different C-RNTI values. So, if a change from c-RNTIList1 to c-RNTIList2 or vice-versa is desired, a 1 bit field is required in a MAC CE. To select a specific C-RNTI in c-RNTIList1, a 6 bit field is needed in a MAC CE, whereas to select a specific C-RNTI in c-RNTIList2, only a 3 bit field is needed. Though it should be noted that, depending what the other fields are, as a MAC CE is octet aligned, the MAC CE may be of the same size in all these cases. However, smaller fields are easier to insert in a MAC CE without increasing the size. For example, a mobility MAC CE pointing to a cell/PCI may be able to include the C-RNTI selection field in the same octet.

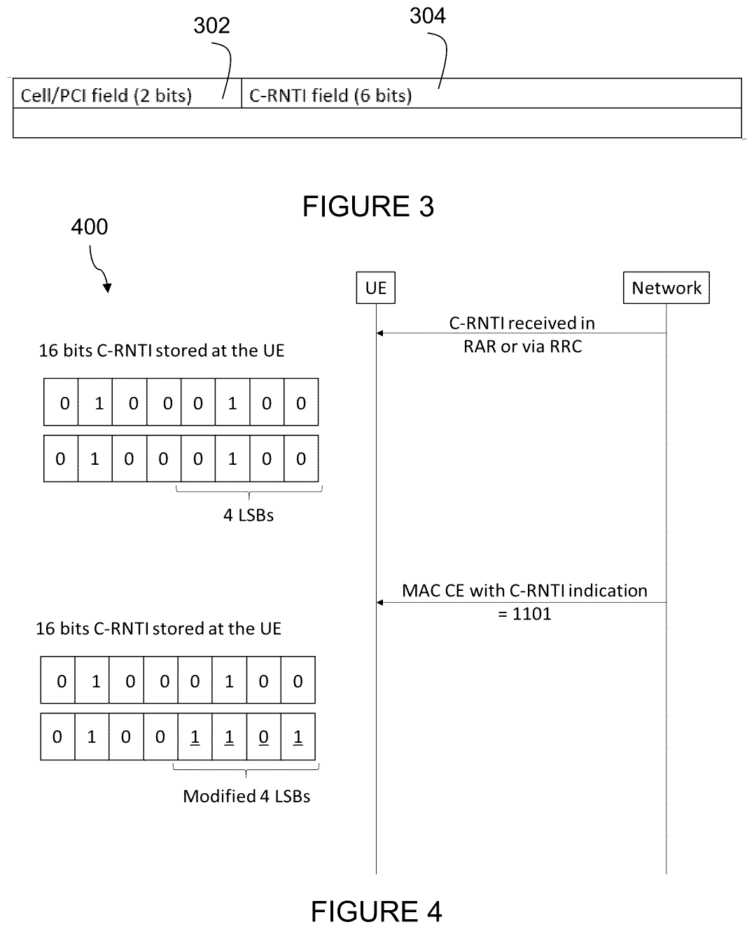

FIG. 3 illustrates an example MAC CE, according to certain embodiments. Specifically, FIG. 3 illustrates that, when 2 bits in a field 302 are used to select the cell/PCI, the octet/field 304 has 6 bits to select the C-RNTI, in a particular embodiment.

In an embodiment, the MAC CE received by the UE in step 2 includes X number of bits of a UE identifier, that may operate at the UE as a delta signaling. For example, if the UE identifier is the C-RNTI with 16 bits, X could be equal to 4, and be defined as the 4 Least Significant Bits (LSB) of the C-RNTI (or the Most Significant Bits (MSB) of the C-RNTI). Then, when the UE receives the MAC CE with these 4 bits, the UE sets its new C-RNTI to a bit string formed by the previous C-RNTI with its 4 LSBs modified by the 4 bits received in the MAC CE. For example, X can be defined in the specifications as a fixed value or X can be a configurable value such as, for example, via RRC so that the C-RNTI allocation for different UEs in different network nodes can be flexible. For example, at the network side, the network node could decide to allocate a range of C-RNTI(s) for a given UE for the different cells/PCIs that are candidate for L1 based mobility, where only the X LBSs or MSB bits are modified and a part of the C-RNTI is fixed, according to a particular embodiment.

FIG. 4 illustrates an example structure 400 of a MAC CE that can be used to update the C-RNTI associated to a UE as described with regard to step 2 above, according to a particular embodiment. It is 8 bits long in this example. Thus, 256 different indexes can be addressed using the C-RNTI Update MAC CE. If the value included is (00000000) then it corresponds to the 1^{st} C-RNTI provided in the C-RNTI list, if the value included is (00000001) then it corresponds to the 2^{nd} C-RNTI provided in the C-RNTI list, if the value included is (00000010) then it corresponds to the 3^{rd} C-RNTI provided in the C-RNTI list and so on.

In an embodiment, a single MAC PDU might contain two MAC CEs. The first MAC CE is changing the serving PCI of the UE (for L1 mobility) by changing the QCL source of the PDCCH to a PCI other than the current serving PCI, and the second MAC CE indicates the new C-RNTI to be used based on the index to the C-RNTI list conveyed in the second MAC CE.

If the network instructs the UE to perform a L1/L2 inter-cell switching and if the UE receives a MAC CE to update the C-RNTI, the UE may perform one or more of the following steps (for methods where the received RRC configurations associated to C-RNTI lists are dependent on the PCI):
1) First, the UE checks if the new PCI and the old PCI uses the same c-RNTI lists based on the C-RNTI lists configured as described above.
2) If the new PCI uses the same c-RNTI list as the source PCI, then the UE decodes the index received in the second MAC CE. Then the UE checks the C-RNTI value corresponding to the received index within the C-RNTI list received via RRC.
3) If the new PCI uses a different c-RNTI list compared to the source PCI, then the UE decodes the index received in the second MAC CE. The UE first picks the C-RNTI list (received via RRC) based on the new PCI and then picks a specific C-RNTI to use based on this list and the index received via the second MAC CE.

In some embodiments, instead of receiving the index to the specific C-RNTI within the C-RNTI list in a MAC CE, this information can be received directly in the MAC CE corresponding to the one that instructs the UE to change the TCI state which is associated to a QCL source of a different PCI than the serving PCI.

For the method of C-RNTI list configuration described above, there could be a MAC PDU containing concatenated MAC CEs wherein the first MAC CE indicates the list to be used and the second MAC CE indicates the index with that C-RNTI list. Alternatively, there can be one MAC CE, as depicted in FIG. 4 and described above.

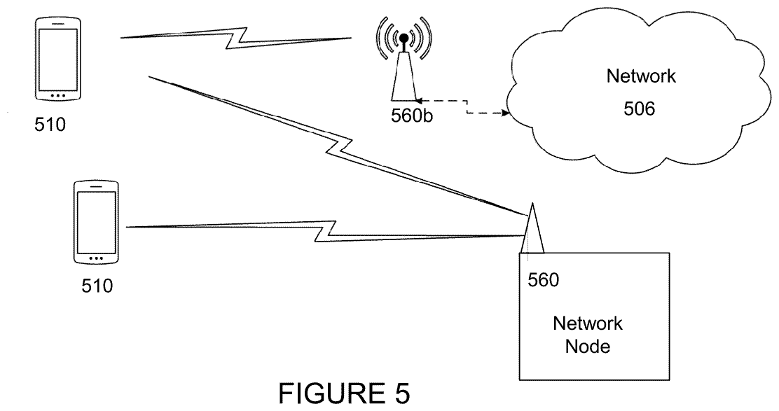

FIG. 5 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 506, network nodes 560 and 560b, and UEs 510. In practice, a wireless network may further include any additional elements suitable to support communication between UEs or between a UE and another communication device, such as a landline telephone, a service provider, or any other network node or end device. Of the illustrated components, network node 560 and UE 510 are depicted with additional detail. The wireless network may provide communication and other types of services to one or more UEs to facilitate the UEs' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 506 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 560 and UE 510 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

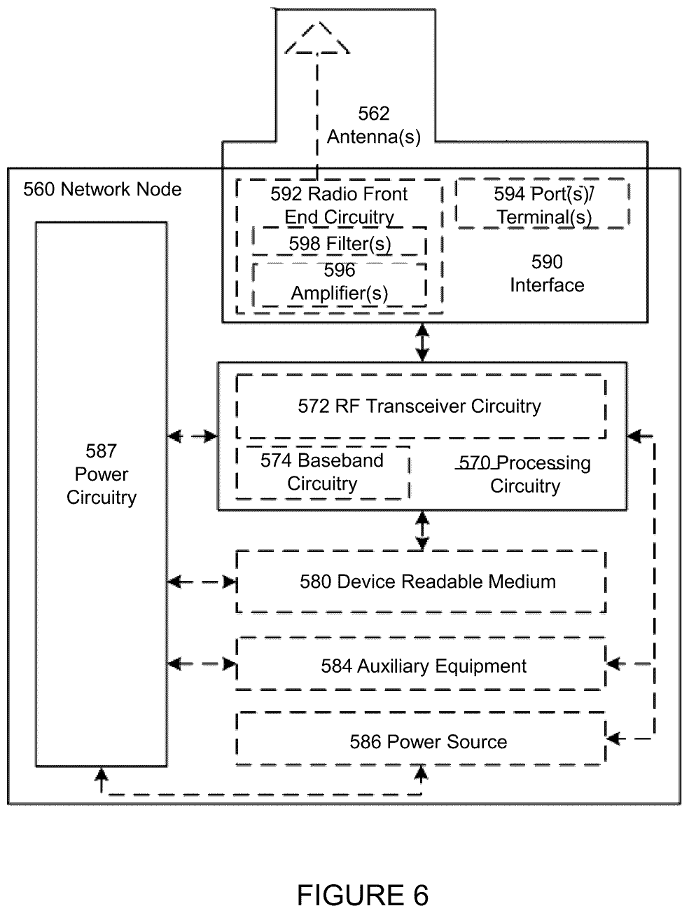

FIG. 6 illustrates an example network node 560, according to certain embodiments. As used herein, network node refers to equipment capable, configured, arranged and/or operable to communicate directly or indirectly with a UE and/or with other network nodes or equipment in the wireless network to enable and/or provide wireless access to the UE and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a UE with access to the wireless network or to provide some service to a UE that has accessed the wireless network.

In FIG. 6, network node 560 includes processing circuitry 570, device readable medium 580, interface 590, auxiliary equipment 584, power source 586, power circuitry 587, and antenna 562. Although network node 560 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 560 are depicted as single boxes located within a larger box, or nested within multiple boxes, in practice, a network node may comprise multiple different physical components that make up a single illustrated component (e.g., device readable medium 580 may comprise multiple separate hard drives as well as multiple RAM modules).

Similarly, network node 560 may be composed of multiple physically separate components (e.g., a NB component and a RNC component, or a BTS component and a BSC component, etc.), which may each have their own respective components. In certain scenarios in which network node 560 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 560 may be configured to support multiple radio access technologies (RATs). In such embodiments, some components may be duplicated (e.g., separate device readable medium 580 for the different RATs) and some components may be reused (e.g., the same antenna 562 may be shared by the RATs). Network node 560 may also include multiple sets of the various illustrated components for different wireless technologies integrated into network node 560, such as, for example, GSM, WCDMA, LTE, NR, WiFi, or Bluetooth wireless technologies. These wireless technologies may be integrated into the same or different chip or set of chips and other components within network node 560.

Processing circuitry 570 is configured to perform any determining, calculating, or similar operations (e.g., certain obtaining operations) described herein as being provided by a network node. In particular, processing circuitry 570 of network node 560 may be configured to perform the methods depicted and described below with regard to FIG. 16. These operations performed by processing circuitry 570 may include processing information obtained by processing circuitry 570 by, for example, converting the obtained information into other information, comparing the obtained information or converted information to information stored in the network node, and/or performing one or more operations based on the obtained information or converted information, and as a result of said processing making a determination.

Processing circuitry 570 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 560 components, such as device readable medium 580, network node 560 functionality. For example, processing circuitry 570 may execute instructions stored in device readable medium 580 or in memory within processing circuitry 570. Such functionality may include providing any of the various wireless features, functions, or benefits discussed herein. In some embodiments, processing circuitry 570 may include a system on a chip (SOC).

In some embodiments, processing circuitry 570 may include one or more of radio frequency (RF) transceiver circuitry 572 and baseband processing circuitry 574. In some embodiments, radio frequency (RF) transceiver circuitry 572 and baseband processing circuitry 574 may be on separate chips (or sets of chips), boards, or units, such as radio units and digital units. In alternative embodiments, part or all of RF transceiver circuitry 572 and baseband processing circuitry 574 may be on the same chip or set of chips, boards, or units.

In certain embodiments, some or all of the functionality described herein as being provided by a network node, base station, eNB or other such network device may be performed by processing circuitry 570 executing instructions stored on device readable medium 580 or memory within processing circuitry 570. In alternative embodiments, some or all of the functionality may be provided by processing circuitry 570 without executing instructions stored on a separate or discrete device readable medium, such as in a hard-wired manner. In any of those embodiments, whether executing instructions stored on a device readable storage medium or not, processing circuitry 570 can be configured to perform the described functionality. The benefits provided by such functionality are not limited to processing circuitry 570 alone or to other components of network node 560 but are enjoyed by network node 560 as a whole, and/or by end users and the wireless network generally.

Device readable medium 580 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 570. Device readable medium 580 may store any suitable instructions, data or information, including a computer program, software, an application including one or more of logic, rules, code, tables, etc. and/or other instructions capable of being executed by processing circuitry 570 and, utilized by network node 560. Device readable medium 580 may be used to store any calculations made by processing circuitry 570 and/or any data received via interface 590. In some embodiments, processing circuitry 570 and device readable medium 580 may be considered to be integrated.

Interface 590 is used in the wired or wireless communication of signalling and/or data between network node 560, network 506, and/or UEs 510. As illustrated, interface 590 comprises port(s)/terminal(s) 594 to send and receive data, for example to and from network 506 over a wired connection. Interface 590 also includes radio front end circuitry 592 that may be coupled to, or in certain embodiments a part of, antenna 562. Radio front end circuitry 592 comprises filters 598 and amplifiers 596. Radio front end circuitry 592 may be connected to antenna 562 and processing circuitry 570. Radio front end circuitry may be configured to condition signals communicated between antenna 562 and processing circuitry 570. Radio front end circuitry 592 may receive digital data that is to be sent out to other network nodes or UEs via a wireless connection. Radio front end circuitry 592 may convert the digital data into a radio signal having the appropriate channel and bandwidth parameters using a combination of filters 598 and/or amplifiers 596. The radio signal may then be transmitted via antenna 562. Similarly, when receiving data, antenna 562 may collect radio signals which are then converted into digital data by radio front end circuitry 592. The digital data may be passed to processing circuitry 570. In other embodiments, the interface may comprise different components and/or different combinations of components.

In certain alternative embodiments, network node 560 may not include separate radio front end circuitry 592, instead, processing circuitry 570 may comprise radio front end circuitry and may be connected to antenna 562 without separate radio front end circuitry 592. Similarly, in some embodiments, all or some of RF transceiver circuitry 572 may be considered a part of interface 590. In still other embodiments, interface 590 may include one or more ports or terminals 594, radio front end circuitry 592, and RF transceiver circuitry 572, as part of a radio unit (not shown), and interface 590 may communicate with baseband processing circuitry 574, which is part of a digital unit (not shown).

Antenna 562 may include one or more antennas, or antenna arrays, configured to send and/or receive wireless signals. Antenna 562 may be coupled to radio front end circuitry 592 and may be any type of antenna capable of transmitting and receiving data and/or signals wirelessly. In some embodiments, antenna 562 may comprise one or more omni-directional, sector or panel antennas operable to transmit/receive radio signals between, for example, 2 GHZ and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 562 may be separate from network node 560 and may be connectable to network node 560 through an interface or port.

Antenna 562, interface 590, and/or processing circuitry 570 may be configured to perform any receiving operations and/or certain obtaining operations described herein as being performed by a network node. Any information, data and/or signals may be received from a UE, another network node and/or any other network equipment. Similarly, antenna 562, interface 590, and/or processing circuitry 570 may be configured to perform any transmitting operations described herein as being performed by a network node. Any information, data and/or signals may be transmitted to a UE, another network node and/or any other network equipment.

Power circuitry 587 may comprise, or be coupled to, power management circuitry and is configured to supply the components of network node 560 with power for performing the functionality described herein. Power circuitry 587 may receive power from power source 586. Power source 586 and/or power circuitry 587 may be configured to provide power to the various components of network node 560 in a form suitable for the respective components (e.g., at a voltage and current level needed for each respective component). Power source 586 may either be included in, or external to, power circuitry 587 and/or network node 560. For example, network node 560 may be connectable to an external power source (e.g., an electricity outlet) via an input circuitry or interface such as an electrical cable, whereby the external power source supplies power to power circuitry 587. As a further example, power source 586 may comprise a source of power in the form of a battery or battery pack which is connected to, or integrated in, power circuitry 587. The battery may provide backup power should the external power source fail. Other types of power sources, such as photovoltaic devices, may also be used.

Alternative embodiments of network node 560 may include additional components beyond those shown in FIG. 6 that may be responsible for providing certain aspects of the network node's functionality, including any of the functionality described herein and/or any functionality necessary to support the subject matter described herein. For example, network node 560 may include user interface equipment to allow input of information into network node 560 and to allow output of information from network node 560. This may allow a user to perform diagnostic, maintenance, repair, and other administrative functions for network node 560.

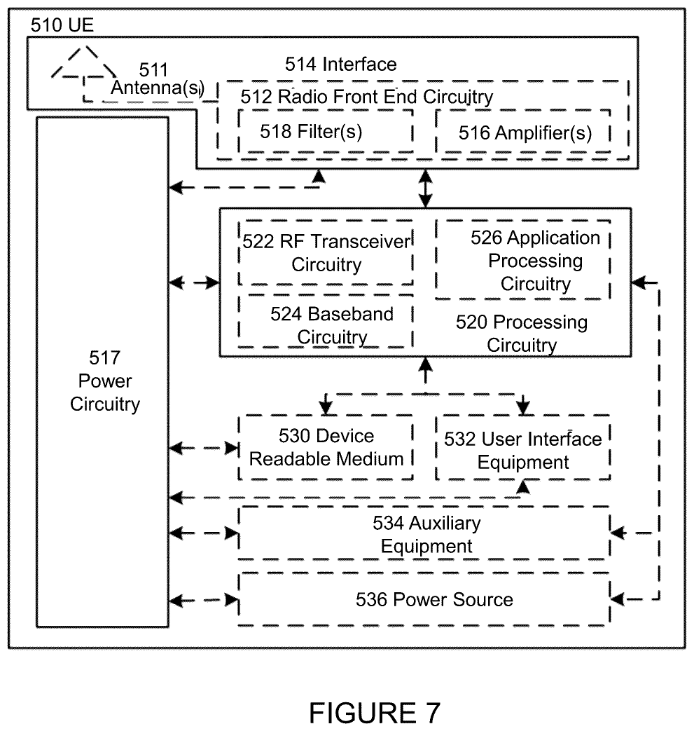

FIG. 7 illustrates an example UE 510. As used herein, UE refers to a device capable, configured, arranged and/or operable to communicate wirelessly with network nodes and/or other UEs. Unless otherwise noted, the term UE may be used interchangeably herein with wireless device. Communicating wirelessly may involve transmitting and/or receiving wireless signals using electromagnetic waves, radio waves, infrared waves, and/or other types of signals suitable for conveying information through air. In some embodiments, a UE may be configured to transmit and/or receive information without direct human interaction. For instance, a UE may be designed to transmit information to a network on a predetermined schedule, when triggered by an internal or external event, or in response to requests from the network. Examples of a UE include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. A UE may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IOT) scenario, a UE may represent a machine or other device that performs monitoring and/or measurements and transmits the results of such monitoring and/or measurements to another UE and/or a network node. The UE may in this case be a machine-to-machine (M2M) device, which may in a 3GPP context be referred to as an MTC device. As one particular example, the UE may be a UE implementing the 3GPP narrow band internet of things (NB-IOT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a UE may represent a vehicle or other equipment that is capable of monitoring and/or reporting on its operational status or other functions associated with its operation. A UE as described above may represent the endpoint of a wireless connection, in which case the device may be referred to as a wireless terminal. Furthermore, a UE as described above may be mobile, in which case it may also be referred to as a mobile device or a mobile terminal.

As illustrated, UE 510 includes antenna 511, interface 514, processing circuitry 520, device readable medium 530, user interface equipment 532, auxiliary equipment 534, power source 536 and power circuitry 537. UE 510 may include multiple sets of one or more of the illustrated components for different wireless technologies supported by UE 510, such as, for example, GSM, WCDMA, LTE, NR, WiFi, WiMAX, or Bluetooth wireless technologies, just to mention a few. These wireless technologies may be integrated into the same or different chips or set of chips as other components within UE 510.

Antenna 511 may include one or more antennas or antenna arrays, configured to send and/or receive wireless signals, and is connected to interface 514. In certain alternative embodiments, antenna 511 may be separate from UE 510 and be connectable to UE 510 through an interface or port. Antenna 511, interface 514, and/or processing circuitry 520 may be configured to perform any receiving or transmitting operations described herein as being performed by a UE. Any information, data and/or signals may be received from a network node and/or another UE. In some embodiments, radio front end circuitry and/or antenna 511 may be considered an interface.

As illustrated, interface 514 comprises radio front end circuitry 512 and antenna 511. Radio front end circuitry 512 comprise one or more filters 518 and amplifiers 516. Radio front end circuitry 512 is connected to antenna 511 and processing circuitry 520 and is configured to condition signals communicated between antenna 511 and processing circuitry 520. Radio front end circuitry 512 may be coupled to or a part of antenna 511. In some embodiments, UE 510 may not include separate radio front end circuitry 512; rather, processing circuitry 520 may comprise radio front end circuitry and may be connected to antenna 511. Similarly, in some embodiments, some or all of RF transceiver circuitry 522 may be considered a part of interface 514. Radio front end circuitry 512 may receive digital data that is to be sent out to other network nodes or UEs via a wireless connection. Radio front end circuitry 512 may convert the digital data into a radio signal having the appropriate channel and bandwidth parameters using a combination of filters 518 and/or amplifiers 516. The radio signal may then be transmitted via antenna 511. Similarly, when receiving data, antenna 511 may collect radio signals which are then converted into digital data by radio front end circuitry 512. The digital data may be passed to processing circuitry 520. In other embodiments, the interface may comprise different components and/or different combinations of components.

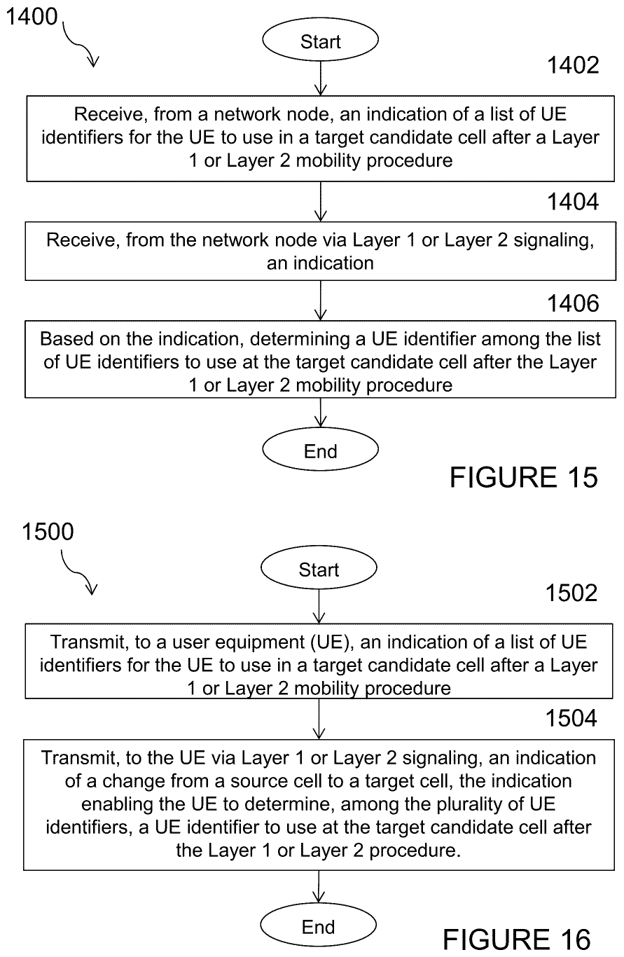

Processing circuitry 520 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other UE 510 components, such as device readable medium 530, UE 510 functionality. Such functionality may include providing any of the various wireless features or benefits discussed herein. For example, processing circuitry 520 may execute instructions stored in device readable medium 530 or in memory within processing circuitry 520 to provide the functionality disclosed herein. In particular, processing circuitry 520 of wireless device 110 may be configured to perform the methods depicted and described below with regard to FIG. 15.

As illustrated, processing circuitry 520 includes one or more of RF transceiver circuitry 522, baseband processing circuitry 524, and application processing circuitry 526. In other embodiments, the processing circuitry may comprise different components and/or different combinations of components. In certain embodiments processing circuitry 520 of UE 510 may comprise a SOC. In some embodiments, RF transceiver circuitry 522, baseband processing circuitry 524, and application processing circuitry 526 may be on separate chips or sets of chips. In alternative embodiments, part or all of baseband processing circuitry 524 and application processing circuitry 526 may be combined into one chip or set of chips, and RF transceiver circuitry 522 may be on a separate chip or set of chips. In still alternative embodiments, part or all of RF transceiver circuitry 522 and baseband processing circuitry 524 may be on the same chip or set of chips, and application processing circuitry 526 may be on a separate chip or set of chips. In yet other alternative embodiments, part or all of RF transceiver circuitry 522, baseband processing circuitry 524, and application processing circuitry 526 may be combined in the same chip or set of chips. In some embodiments, RF transceiver circuitry 522 may be a part of interface 514. RF transceiver circuitry 522 may condition RF signals for processing circuitry 520.

In certain embodiments, some or all of the functionality described herein as being performed by a UE may be provided by processing circuitry 520 executing instructions stored on device readable medium 530, which in certain embodiments may be a computer-readable storage medium. In alternative embodiments, some or all of the functionality may be provided by processing circuitry 520 without executing instructions stored on a separate or discrete device readable storage medium, such as in a hard-wired manner. In any of those particular embodiments, whether executing instructions stored on a device readable storage medium or not, processing circuitry 520 can be configured to perform the described functionality. The benefits provided by such functionality are not limited to processing circuitry 520 alone or to other components of UE 510, but are enjoyed by UE 510 as a whole, and/or by end users and the wireless network generally.

Processing circuitry 520 may be configured to perform any determining, calculating, or similar operations (e.g., certain obtaining operations) described herein as being performed by a UE. These operations, as performed by processing circuitry 520, may include processing information obtained by processing circuitry 520 by, for example, converting the obtained information into other information, comparing the obtained information or converted information to information stored by UE 510, and/or performing one or more operations based on the obtained information or converted information, and as a result of said processing making a determination.

Device readable medium 530 may be operable to store a computer program, software, an application including one or more of logic, rules, code, tables, etc. and/or other instructions capable of being executed by processing circuitry 520. Device readable medium 530 may include computer memory (e.g. RAM or ROM), mass storage media (e.g., a hard disk), removable storage media (e.g., a CD or a DVD), and/or any other volatile or non-volatile, non-transitory device readable and/or computer executable memory devices that store information, data, and/or instructions that may be used by processing circuitry 520. In some embodiments, processing circuitry 520 and device readable medium 530 may be considered to be integrated.

User interface equipment 532 may provide components that allow for a human user to interact with UE 510. Such interaction may be of many forms, such as visual, audial, tactile, etc. User interface equipment 532 may be operable to produce output to the user and to allow the user to provide input to UE 510. The type of interaction may vary depending on the type of user interface equipment 532 installed in UE 510. For example, if UE 510 is a smart phone, the interaction may be via a touch screen; if UE 510 is a smart meter, the interaction may be through a screen that provides usage (e.g., the number of gallons used) or a speaker that provides an audible alert (e.g., if smoke is detected). User interface equipment 532 may include input interfaces, devices and circuits, and output interfaces, devices and circuits. User interface equipment 532 is configured to allow input of information into UE 510 and is connected to processing circuitry 520 to allow processing circuitry 520 to process the input information. User interface equipment 532 may include, for example, a microphone, a proximity or other sensor, keys/buttons, a touch display, one or more cameras, a USB port, or other input circuitry. User interface equipment 532 is also configured to allow output of information from UE 510, and to allow processing circuitry 520 to output information from UE 510. User interface equipment 532 may include, for example, a speaker, a display, vibrating circuitry, a USB port, a headphone interface, or other output circuitry. Using one or more input and output interfaces, devices, and circuits, of user interface equipment 532, UE 510 may communicate with end users and/or the wireless network and allow them to benefit from the functionality described herein.

Auxiliary equipment 534 is operable to provide more specific functionality which may not be generally performed by UEs. This may comprise specialized sensors for doing measurements for various purposes, interfaces for additional types of communication such as wired communications etc. The inclusion and type of components of auxiliary equipment 534 may vary depending on the embodiment and/or scenario.

Power source 536 may, in some embodiments, be in the form of a battery or battery pack. Other types of power sources, such as an external power source (e.g., an electricity outlet), photovoltaic devices or power cells, may also be used. UE 510 may further comprise power circuitry 537 for delivering power from power source 536 to the various parts of UE 510 which need power from power source 536 to carry out any functionality described or indicated herein. Power circuitry 537 may in certain embodiments comprise power management circuitry. Power circuitry 537 may additionally or alternatively be operable to receive power from an external power source; in which case UE 510 may be connectable to the external power source (such as an electricity outlet) via input circuitry or an interface such as an electrical power cable. Power circuitry 537 may also in certain embodiments be operable to deliver power from an external power source to power source 536. This may be, for example, for the charging of power source 536. Power circuitry 537 may perform any formatting, converting, or other modification to the power from power source 536 to make the power suitable for the respective components of UE 510 to which power is supplied.

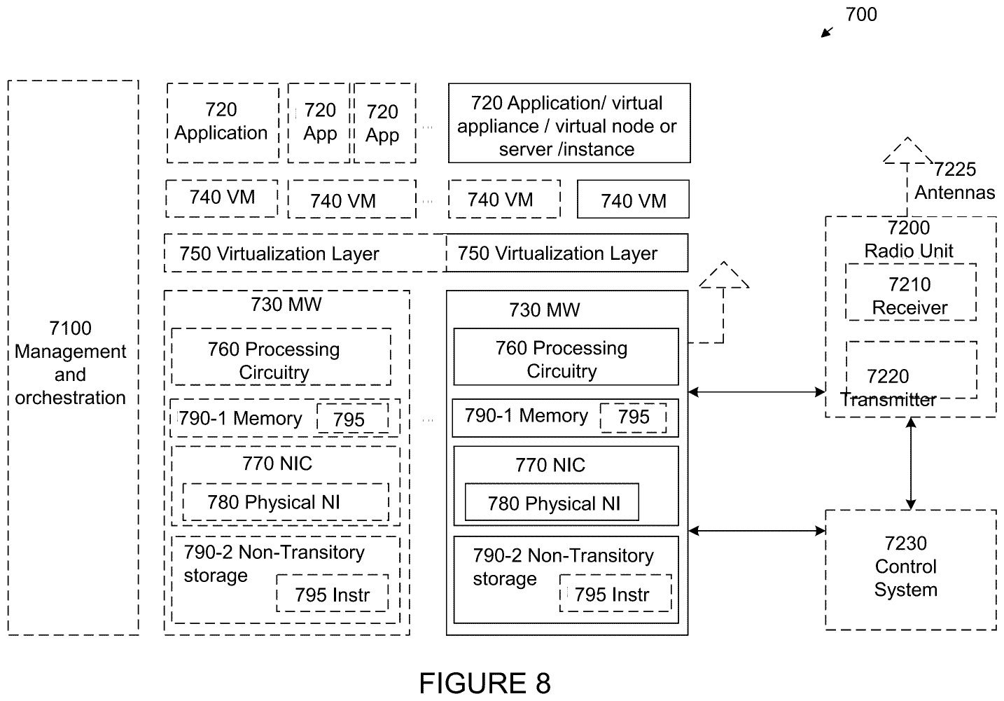

FIG. 8 is a schematic block diagram illustrating a virtualization environment 700 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 700 hosted by one or more of hardware nodes 730. Further, in embodiments in which the virtual node is not a radio access node or does not require radio connectivity (e.g., a core network node), then the network node may be entirely virtualized.

The functions may be implemented by one or more applications 720 (which may alternatively be called software instances, virtual appliances, network functions, virtual nodes, virtual network functions, etc.) operative to implement some of the features, functions, and/or benefits of some of the embodiments disclosed herein. Applications 720 are run in virtualization environment 700 which provides hardware 730 comprising processing circuitry 760 and memory 790. Memory 790 contains instructions 795 executable by processing circuitry 760 whereby application 720 is operative to provide one or more of the features, benefits, and/or functions disclosed herein.

Virtualization environment 700, comprises general-purpose or special-purpose network hardware devices 730 comprising a set of one or more processors or processing circuitry 760, which may be commercial off-the-shelf (COTS) processors, dedicated Application Specific Integrated Circuits (ASICs), or any other type of processing circuitry including digital or analog hardware components or special purpose processors. Each hardware device may comprise memory 790-1 which may be non-persistent memory for temporarily storing instructions 795 or software executed by processing circuitry 760. Each hardware device may comprise one or more network interface controllers (NICs) 770, also known as network interface cards, which include physical network interface 780. Each hardware device may also include non-transitory, persistent, machine-readable storage media 790-2 having stored therein software 795 and/or instructions executable by processing circuitry 760. Software 795 may include any type of software including software for instantiating one or more virtualization layers 750 (also referred to as hypervisors), software to execute virtual machines 740 as well as software allowing it to execute functions, features and/or benefits described in relation with some embodiments described herein.

Virtual machines 740, comprise virtual processing, virtual memory, virtual networking or interface and virtual storage, and may be run by a corresponding virtualization layer 750 or hypervisor. Different embodiments of the instance of virtual appliance 720 may be implemented on one or more of virtual machines 740, and the implementations may be made in different ways.

During operation, processing circuitry 760 executes software 795 to instantiate the hypervisor or virtualization layer 750, which may sometimes be referred to as a virtual machine monitor (VMM). Virtualization layer 750 may present a virtual operating platform that appears like networking hardware to virtual machine 740.

As shown in FIG. 8, hardware 730 may be a standalone network node with generic or specific components. Hardware 730 may comprise antenna 7225 and may implement some functions via virtualization. Alternatively, hardware 730 may be part of a larger cluster of hardware (e.g. such as in a data center or customer premise equipment (CPE)) where many hardware nodes work together and are managed via management and orchestration (MANO) 7100, which, among others, oversees lifecycle management of applications 720.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 740 may be a software implementation of a physical machine that runs programs as if they were executing on a physical, non-virtualized machine. Each of virtual machines 740, and that part of hardware 730 that executes that virtual machine, be it hardware dedicated to that virtual machine and/or hardware shared by that virtual machine with others of the virtual machines 740, forms a separate virtual network elements (VNE).

Still in the context of NFV, Virtual Network Function (VNF) is responsible for handling specific network functions that run in one or more virtual machines 740 on top of hardware networking infrastructure 730 and corresponds to application 720 in FIG. 8.

In some embodiments, one or more radio units 7200 that each include one or more transmitters 7220 and one or more receivers 7210 may be coupled to one or more antennas 7225. Radio units 7200 may communicate directly with hardware nodes 730 via one or more appropriate network interfaces and may be used in combination with the virtual components to provide a virtual node with radio capabilities, such as a radio access node or a base station.

In some embodiments, some signaling can be affected with the use of control system 7230 which may alternatively be used for communication between the hardware nodes 730 and radio units 7200.

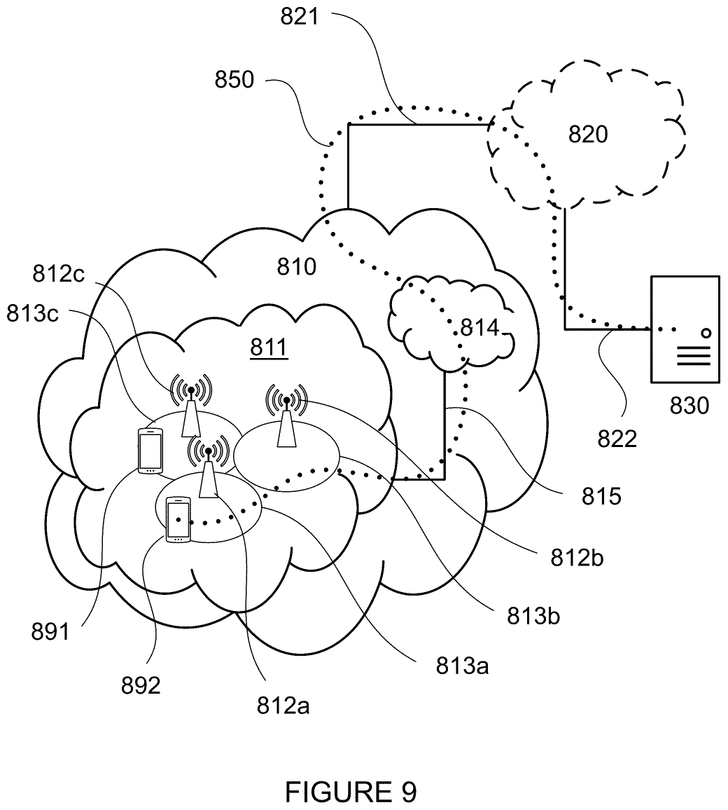

FIG. 9 illustrates a telecommunication network connected via an intermediate network to a host computer in accordance with some embodiments.

With reference to FIG. 9, in accordance with an embodiment, a communication system includes telecommunication network 810, such as a 3GPP-type cellular network, which comprises access network 811, such as a radio access network, and core network 814. Access network 811 comprises a plurality of base stations 812a, 812b, 812c, such as NBs, eNBs, gNBs or other types of wireless access points, each defining a corresponding coverage area 813a, 813b, 813c. Each base station 812a, 812b, 812c is connectable to core network 814 over a wired or wireless connection 815. A first UE 891 located in coverage area 813c is configured to wirelessly connect to, or be paged by, the corresponding base station 812c. A second UE 892 in coverage arca 813a is wirelessly connectable to the corresponding base station 812a. While a plurality of UEs 891, 892 are illustrated in this example, the disclosed embodiments are equally applicable to a situation where a sole UE is in the coverage area or where a sole UE is connecting to the corresponding base station 812.

Telecommunication network 810 is itself connected to host computer 830, which may be embodied in the hardware and/or software of a standalone server, a cloud-implemented server, a distributed server or as processing resources in a server farm. Host computer 830 may be under the ownership or control of a service provider or may be operated by the service provider or on behalf of the service provider. Connections 821 and 822 between telecommunication network 810 and host computer 830 may extend directly from core network 814 to host computer 830 or may go via an optional intermediate network 820. Intermediate network 820 may be one of, or a combination of more than one of, a public, private or hosted network; intermediate network 820, if any, may be a backbone network or the Internet; in particular, intermediate network 820 may comprise two or more sub-networks (not shown).

The communication system of FIG. 9 as a whole enables connectivity between the connected UEs 891, 892 and host computer 830. The connectivity may be described as an over-the-top (OTT) connection 850. Host computer 830 and the connected UEs 891, 892 are configured to communicate data and/or signaling via OTT connection 850, using access network 811, core network 814, any intermediate network 820 and possible further infrastructure (not shown) as intermediaries. OTT connection 850 may be transparent in the sense that the participating communication devices through which OTT connection 850 passes are unaware of routing of uplink and downlink communications. For example, base station 812 may not or need not be informed about the past routing of an incoming downlink communication with data originating from host computer 830 to be forwarded (e.g., handed over) to a connected UE 891. Similarly, base station 812 need not be aware of the future routing of an outgoing uplink communication originating from the UE 891 towards the host computer 830.

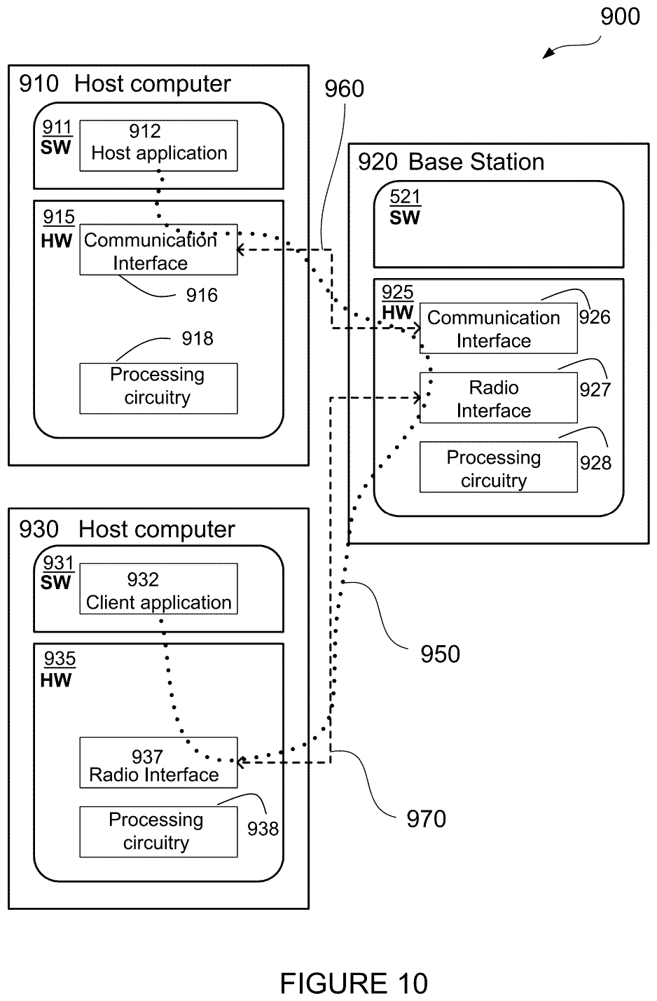

FIG. 10 illustrates a host computer communicating via a base station with a UE over a partially wireless connection in accordance with some embodiments.

Example implementations, in accordance with an embodiment, of the UE, base station and host computer discussed in the preceding paragraphs will now be described with reference to FIG. 10. In communication system 900, host computer 910 comprises hardware 915 including communication interface 916 configured to set up and maintain a wired or wireless connection with an interface of a different communication device of communication system 900. Host computer 910 further comprises processing circuitry 918, which may have storage and/or processing capabilities. In particular, processing circuitry 918 may comprise one or more programmable processors, application-specific integrated circuits, field programmable gate arrays or combinations of these (not shown) adapted to execute instructions. Host computer 910 further comprises software 911, which is stored in or accessible by host computer 910 and executable by processing circuitry 918. Software 911 includes host application 912. Host application 912 may be operable to provide a service to a remote user, such as UE 930 connecting via OTT connection 950 terminating at UE 930 and host computer 910. In providing the service to the remote user, host application 912 may provide user data which is transmitted using OTT connection 950.

Communication system 900 further includes base station 920 provided in a telecommunication system and comprising hardware 925 enabling it to communicate with host computer 910 and with UE 930. Hardware 925 may include communication interface 926 for setting up and maintaining a wired or wireless connection with an interface of a different communication device of communication system 900, as well as radio interface 927 for setting up and maintaining at least wireless connection 970 with UE 930 located in a coverage arca (not shown in FIG. 10) served by base station 920. Communication interface 926 may be configured to facilitate connection 960 to host computer 910. Connection 960 may be direct or it may pass through a core network (not shown in FIG. 10) of the telecommunication system and/or through one or more intermediate networks outside the telecommunication system. In the embodiment shown, hardware 925 of base station 920 further includes processing circuitry 928, which may comprise one or more programmable processors, application-specific integrated circuits, field programmable gate arrays or combinations of these (not shown) adapted to execute instructions. Base station 920 further has software 921 stored internally or accessible via an external connection.

Communication system 900 further includes UE 930 already referred to. Its hardware 935 may include radio interface 937 configured to set up and maintain wireless connection 970 with a base station serving a coverage area in which UE 930 is currently located. Hardware 935 of UE 930 further includes processing circuitry 938, which may comprise one or more programmable processors, application-specific integrated circuits, field programmable gate arrays or combinations of these (not shown) adapted to execute instructions. UE 930 further comprises software 931, which is stored in or accessible by UE 930 and executable by processing circuitry 938. Software 931 includes client application 932. Client application 932 may be operable to provide a service to a human or non-human user via UE 930, with the support of host computer 910. In host computer 910, an executing host application 912 may communicate with the executing client application 932 via OTT connection 950 terminating at UE 930 and host computer 910. In providing the service to the user, client application 932 may receive request data from host application 912 and provide user data in response to the request data. OTT connection 950 may transfer both the request data and the user data. Client application 932 may interact with the user to generate the user data that it provides.

It is noted that host computer 910, base station 920 and UE 930 illustrated in FIG. 10 may be similar or identical to host computer 830, one of base stations 812a, 812b, 812c and one of UEs 891, 892 of FIG. 9, respectively. This is to say, the inner workings of these entities may be as shown in FIG. 10 and independently, the surrounding network topology may be that of FIG. 9.

In FIG. 10, OTT connection 950 has been drawn abstractly to illustrate the communication between host computer 910 and UE 930 via base station 920, without explicit reference to any intermediary devices and the precise routing of messages via these devices. Network infrastructure may determine the routing, which it may be configured to hide from UE 930 or from the service provider operating host computer 910, or both. While OTT connection 950 is active, the network infrastructure may further take decisions by which it dynamically changes the routing (e.g., on the basis of load balancing consideration or reconfiguration of the network).

Wireless connection 970 between UE 930 and base station 920 is in accordance with the teachings of the embodiments described throughout this disclosure. One or more of the various embodiments improve the performance of OTT services provided to UE 930 using OTT connection 950, in which wireless connection 970 forms the last segment. More precisely, the teachings of these embodiments may improve the data rate, latency, and/or power consumption and thereby provide benefits such as reduced user waiting time, relaxed restriction on file size, better responsiveness, and/or extended battery lifetime.

A measurement procedure may be provided for the purpose of monitoring data rate, latency and other factors on which the one or more embodiments improve. There may further be an optional network functionality for reconfiguring OTT connection 950 between host computer 910 and UE 930, in response to variations in the measurement results. The measurement procedure and/or the network functionality for reconfiguring OTT connection 950 may be implemented in software 911 and hardware 915 of host computer 910 or in software 931 and hardware 935 of UE 930, or both. In embodiments, sensors (not shown) may be deployed in or in association with communication devices through which OTT connection 950 passes; the sensors may participate in the measurement procedure by supplying values of the monitored quantities exemplified above or supplying values of other physical quantities from which software 911, 931 may compute or estimate the monitored quantities. The reconfiguring of OTT connection 950 may include message format, retransmission settings, preferred routing etc.; the reconfiguring need not affect base station 920, and it may be unknown or imperceptible to base station 920. Such procedures and functionalities may be known and practiced in the art. In certain embodiments, measurements may involve proprietary UE signaling facilitating host computer 910's measurements of throughput, propagation times, latency and the like. The measurements may be implemented in that software 911 and 931 causes messages to be transmitted, in particular empty or ‘dummy’ messages, using OTT connection 950 while it monitors propagation times, errors etc.

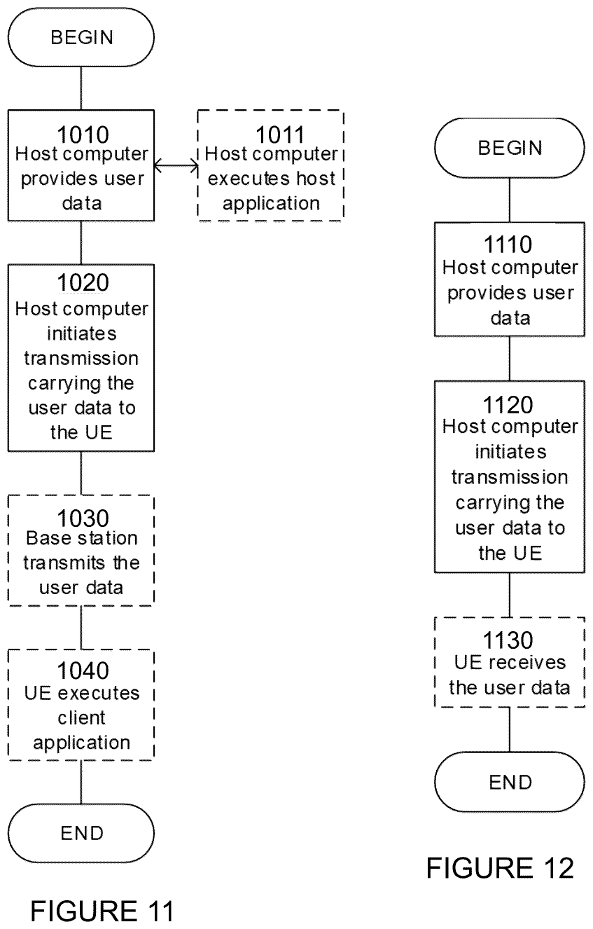

FIG. 11 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 11 will be included in this section. In step 1010, the host computer provides user data. In substep 1011 (which may be optional) of step 1010, the host computer provides the user data by executing a host application. In step 1020, the host computer initiates a transmission carrying the user data to the UE. In step 1030 (which may be optional), the base station transmits to the UE the user data which was carried in the transmission that the host computer initiated, in accordance with the teachings of the embodiments described throughout this disclosure. In step 1040 (which may also be optional), the UE executes a client application associated with the host application executed by the host computer.

FIG. 12 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 12 will be included in this section. In step 1110 of the method, the host computer provides user data. In an optional substep (not shown) the host computer provides the user data by executing a host application. In step 1120, the host computer initiates a transmission carrying the user data to the UE. The transmission may pass via the base station, in accordance with the teachings of the embodiments described throughout this disclosure. In step 1130 (which may be optional), the UE receives the user data carried in the transmission.

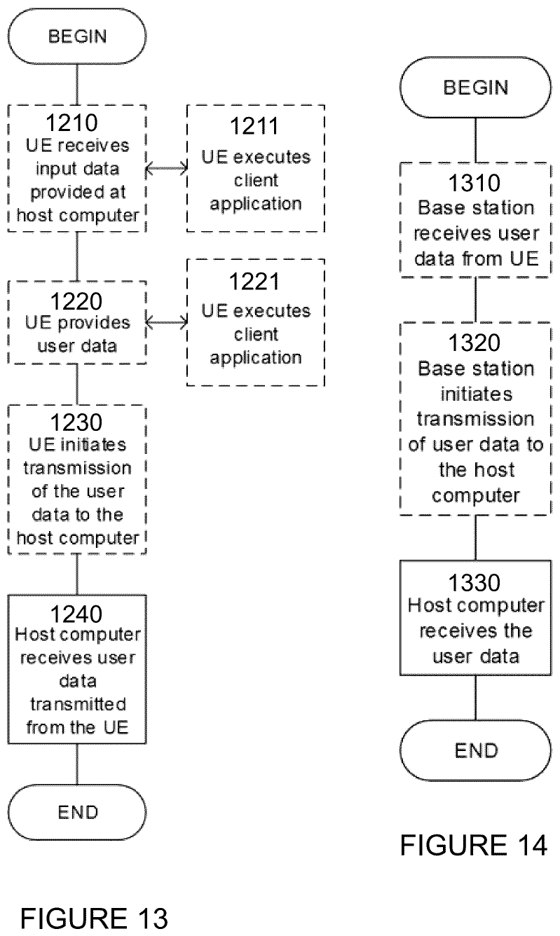

FIG. 13 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 13 will be included in this section. In step 1210 (which may be optional), the UE receives input data provided by the host computer. Additionally or alternatively, in step 1220, the UE provides user data. In substep 1221 (which may be optional) of step 1220, the UE provides the user data by executing a client application. In substep 1211 (which may be optional) of step 1210, the UE executes a client application which provides the user data in reaction to the received input data provided by the host computer. In providing the user data, the executed client application may further consider user input received from the user. Regardless of the specific manner in which the user data was provided, the UE initiates, in substep 1230 (which may be optional), transmission of the user data to the host computer. In step 1240 of the method, the host computer receives the user data transmitted from the UE, in accordance with the teachings of the embodiments described throughout this disclosure.

FIG. 14 is a flowchart illustrating a method implemented in a communication system, in accordance with one embodiment. The communication system includes a host computer, a base station and a UE which may be those described with reference to FIGS. 9 and 10. For simplicity of the present disclosure, only drawing references to FIG. 14 will be included in this section. In step 1310 (which may be optional), in accordance with the teachings of the embodiments described throughout this disclosure, the base station receives user data from the UE. In step 1320 (which may be optional), the base station initiates transmission of the received user data to the host computer. In step 1330 (which may be optional), the host computer receives the user data carried in the transmission initiated by the base station.

FIG. 15 illustrates an example method 1400 by a UE 510, according to certain embodiments. The method includes receiving, from a network node 560, an indication of a list of UE identifiers for the UE 510 to use in a target candidate cell after a L1 or L2 mobility procedure, at step 1402. At step 1404, the UE 510 receives, from network node 560 via L1 or L2 signaling, an indication. Based on the indication, the UE 510 determines a UE identifier among the list of UE identifiers to use at the target candidate cell after the L1 or L2 mobility procedure, at step 1406.

In a particular embodiment, the list of UE identifiers includes one or more UE identifiers.

In a particular embodiment, the UE 510 performs one of receiving and transmitting data in the target cell based on the indicated UE identifier.

In a particular embodiment, the L1 or L2 signaling indicates a TCI state, and UE 510 determines a SSB of the target cell based on the TCI state. The UE 510 further determines the UE identifier to use at the target cell based on the SSB.

In a particular embodiment, the UE 510 performs the L1 or L2 mobility procedure, and the L1 or L2 mobility procedure is or includes a beam management operation expanding a coverage of a plurality of SSBs associated to a plurality of PCIs.

In a particular embodiment, the list of UE identifiers is associated with a plurality of PCIs of a plurality of target candidate cells in L1 or L2 mobility procedure.

In a particular embodiment, the list of UE identifiers is associated with a single PCI associated with the target candidate cell.

In a particular embodiment, the determined UE identifier is associated with a PCI of the target candidate cell of the L1 or L2 mobility procedure.

In a particular embodiment, the UE 510 receives at least one additional list of UE identifiers, and each additional list comprises at least one additional UE identifier of which the wireless device is configured to use in one of a plurality of target candidate cells.

In a particular embodiment, the list comprising the UE identifiers comprises a list of a plurality of C-RNTIs.

In a particular embodiment, the indication comprises a C-RNTI to use in the target candidate cell after the Layer 1 or Layer 2 mobility procedure.

In a further particular embodiment, the indication comprises a PCI associated with the target candidate cell. When determining the UE identifier among the list of UE identifiers, the UE 510 determines a C-RNTI to use at the target candidate cell after the Layer 1 or Layer 2 mobility procedure based on the PCI.

In a particular embodiment, the indication further comprises an indication of a cell group associated with the list of UE identifiers.

In a further particular embodiment, the cell group comprises a master cell group or a secondary cell group to which the target candidate cell belongs.

In a particular embodiment, the list of UE identifiers is received as a RRC message.

In a particular embodiment, the indication is received via a MAC CE.

In a particular embodiment, the MAC CE comprises at least one bit for indicating a UE identifier. When determining the UE identifier among the list of UE identifiers to use at the target candidate cell, the UE 510 replaces a portion of a previous UE identifier with the at least one bit to arrive at the determined UE identifier.

In a particular embodiment, the indication is received via DCI.

In a particular embodiment, the UE 510 uses the determined UE identifier in the target candidate cell in the place of another UE identifier used prior to the Layer 1 or Layer 2 mobility procedure.

FIG. 16 illustrates another example method 1500 by a network node 560, according to certain embodiments. The method begins at step 1502 when the network node 560 includes transmits, to a UE 510, an indication of a list of UE identifiers for the UE to use in a target candidate cell after a L1 or L2 mobility procedure. At step 1504, the UE transmits, to the UE via L1 or L2 signaling, an indication of a change from a source cell to a target cell, and the indication enables the UE 510 to determine, among the list of UE identifiers, a UE identifier to use at the target candidate cell after the L1 or L2 procedure.

In a particular embodiment, the network node 560 performs one of receiving and transmitting data based on the UE identifier determined by the UE 510.

In a particular embodiment, the L1 or L2 signaling indicates a TCI state for determining a SSB of the target cell by the UE 510, and the UE identifier for use at the target cell is determined based on the SSB.

In a particular embodiment, the L1 or L2 mobility procedure comprises a beam management operation expanding a coverage of a plurality of SSBs associated to a plurality of PCIs.

In a particular embodiment, the list of UE identifiers is associated with a plurality of PCIs of a plurality of target candidate cells in L1 or L2 mobility procedure.

In a particular embodiment, the list of UE identifiers is associated with a single PCI associated with the target candidate cell.

In a particular embodiment, the UE identifier for use in the target cell is associated with a PCI of the target candidate cell of the Layer 1 or Layer 2 mobility procedure.

In a particular embodiment, the network node 560 transmits at least one additional list of UE identifiers, and each additional list comprises at least one additional UE identifier of which the UE 510 is configured to use in one of a plurality of target candidate cells.

In a particular embodiment, the list comprising the UE identifiers comprises a list of a plurality of C-RNTIs.

In a particular embodiment, the indication comprises a C-RNTI to use in the target candidate cell after the L1 or L2 mobility procedure.

In a particular embodiment, the indication comprises a PCI associated with the target candidate cell, and the PCI is used by the UE 510 to determine the UE identifier.

In a particular embodiment, the indication further comprises an indication of a cell group associated with the list of UE identifiers.

In a further particular embodiment, the cell group comprises a master cell group or a secondary cell group to which the target candidate cell belongs.

In a particular embodiment, the list of UE identifiers is transmitted as a RRC message. In a particular embodiment, the indication is transmitted via a MAC CE.

In a particular embodiment, the MAC CE comprises at least one bit that the UE is configured to use as a replacement for a portion of a UE identifier in the list of UE identifiers to arrive at the determined UE identifier.

In a particular embodiment, the indication is transmitted via DCI.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a User Equipment, UE, the method comprising:
receiving, from a network node, an indication of a list of UE identifiers for the UE to use in a target candidate cell after a Layer 1 or Layer 2 mobility procedure;
receiving, from the network node via Layer 1 or Layer 2 signaling, an indication; and
based on the indication, determining a UE identifier among the list of UE identifiers to use at the target candidate cell after the Layer 1 or Layer 2 mobility procedure.

2.-18. (canceled)

19. A method by a network node, the method comprising:
transmitting, to a user equipment, UE, an indication of a list of UE identifiers for the UE to use in a target candidate cell after a Layer 1 or Layer 2 mobility procedure;
transmitting, to the UE via Layer 1 or Layer 2 signaling, an indication of a change from a source cell to a target cell, wherein the indication enables the UE to determine, among the list of UE identifiers, a UE identifier to use at the target candidate cell after the Layer 1 or Layer 2 procedure.

20.-34. (canceled)

35. The method of claim 19, wherein the indication is transmitted via downlink control information, DCI.

35. A wireless device adapted to:
receive, from a network node, an indication of a list of UE identifiers for the UE to use in a target candidate cell after a Layer 1 or Layer 2 mobility procedure;
receive, from the network node via Layer 1 or Layer 2 signaling, an indication; and
based on the indication, determine a UE identifier among the list of UE identifiers to use at the target candidate cell after the Layer 1 or Layer 2 mobility procedure.

36. The wireless device of claim 35, wherein the wireless device is adapted to perform one of receiving and transmitting data in the target cell based on the indicated UE identifier.

37. The wireless device of claim 35, wherein the Layer 1 or Layer 2 signaling indicates a Transmission Configuration Indicator, TCI, state, and wherein the wireless device is adapted to:
determine a Synchronization Signal Block, SSB, of the target cell based on the TCI state; and
determine the UE identifier to use at the target cell based on the SSB.

38. The wireless device of claim 35, wherein the wireless device is adapted to performing the Layer 1 or Layer 2 mobility procedure, and wherein the Layer 1 or Layer 2 mobility procedure comprises a beam management operation expanding a coverage of a plurality of SSBs associated to a plurality of Physical Cell Identifiers, PCIs.

39. The wireless device of claim 35, wherein the list of UE identifiers is associated with a plurality of PCIs of a plurality of target candidate cells in Layer 1 or Layer 2 mobility procedure.

40. The wireless device of claim 35, wherein the list of UE identifiers is associated with a single PCI associated with the target candidate cell.

41. The wireless device of claim 35, wherein the determined UE identifier is associated with a PCI of the target candidate cell of the Layer 1 or Layer 2 mobility procedure.

42. The wireless device of claim 35, wherein the wireless device is adapted to receive at least one additional list of UE identifiers, wherein each additional list comprises at least one additional UE identifier of which the wireless device is configured to use in one of a plurality of target candidate cells.

43. The wireless device of claim 35, wherein the list comprising the UE identifiers comprises a list of a plurality of Cell-Radio Network Temporary Identifiers, C-RNTIs.

44. The wireless device of claim 43, wherein the indication comprises a C-RNTI to use in the target candidate cell after the Layer 1 or Layer 2 mobility procedure.

46. The wireless device of claim 43, wherein:
the indication comprises a PCI associated with the target candidate cell, and
when determining the UE identifier among the list of UE identifiers, the wireless device is adapted to determine a C-RNTI to use at the target candidate cell after the Layer 1 or Layer 2 mobility procedure based on the PCI.

47. The wireless device of claim 35, wherein the indication further comprises an indication of a cell group associated with the list of UE identifiers.

48. The wireless device of claim 47, wherein the cell group comprises a master cell group or a secondary cell group to which the target candidate cell belongs.

49. The wireless device of claim 35, wherein the list of UE identifiers is received as a Radio Resource Control, RRC, message.

50. The wireless device of claim 35, wherein the indication is received via a Medium Access Control-Control Element, MAC CE.

51. The wireless device of claim 50, wherein;
the MAC CE comprises at least one bit for indicating a UE identifier, and
when determining the UE identifier among the list of UE identifiers to use at the target candidate cell, the wireless device is adapted to replace a portion of a previous UE identifier with the at least one bit to arrive at the determined UE identifier.

52. The wireless device of claim 35, wherein the indication is received via downlink control information, DCI.

53. The wireless device of claim 35, wherein the wireless device is adapted to use the determined UE identifier in the target candidate cell in the place of another UE identifier used prior to the Layer 1 or Layer 2 mobility procedure.

54. A network node adapted to:
transmit, to a user equipment, UE, an indication of a list of UE identifiers for the UE to use in a target candidate cell after a Layer 1 or Layer 2 mobility procedure;
transmit, to the UE via Layer 1 or Layer 2 signaling, an indication of a change from a source cell to a target cell, wherein the indication enables the UE to determine, among the list of UE identifiers, a UE identifier to use at the target candidate cell after the Layer 1 or Layer 2 procedure.

55. The network node of claim 54, wherein the network node is adapted to perform one of receiving and transmitting data based on the UE identifier determined by the UE.

56. The network node of claim 54, wherein the Layer 1 or Layer 2 signaling indicates a Transmission Configuration Indicator, TCI, state, for determining a Synchronization Signal Block, SSB, of the target cell by the UE, and wherein the UE identifier to use at the target cell is determined based on the SSB.

57. The network node of claim 54, wherein the Layer 1 or Layer 2 mobility procedure comprises a beam management operation expanding a coverage of a plurality of SSBs associated to a plurality of Physical Cell Identifiers, PCIs.

58. The network node of claim 54, wherein the list of UE identifiers is associated with a plurality of PCIs of a plurality of target candidate cells in Layer 1 or Layer 2 mobility procedure.

59.-70. (canceled)
